(19) United States
(12) Patent Application Publication
(10) Pub. No.: US 2026/0109295 A1
(43) Pub. Date: Apr. 23, 2026

(54) VEHICULAR LOW-PROFILE EXTERIOR MIRROR ACTUATOR

(71) Applicant: Magna Mirrors of America, Inc., Holland, MI (US)

(72) Inventor: Matthew V. Steffes, Grand Rapids, MI (US)

(21) Appl. No.: 19/358,825

(22) Filed: Oct. 15, 2025

Related U.S. Application Data
(60) Provisional application No. 63/709,638, filed on Oct. 21, 2024.

(51) Int. Cl. B60R 1/074; G02B 7/198

(52) U.S. Cl. CPC B60R 1/074; G02B 7/198

(57) ABSTRACT

A vehicular exterior rearview mirror assembly includes a mirror head accommodating a mirror reflective element. The mirror head is movable relative to a mounting base between an extended position and a folded position. An actuator is electrically operable to move the mirror head between the positions and includes a base portion disposed at the mounting base and a pivot tube extending from the base portion through an output gear and a housing. The output gear is rotatably fixed relative to the base portion, and the mirror head and housing pivot together and in tandem about the output gear and a longitudinal axis of the pivot tube. A portion of the housing extends between an upper end of the pivot tube and a surface of the housing, and a biasing element disposed radially inboard of the portion of the housing releasably retains the actuator in at least one detent state.

### CROSS REFERENCE TO RELATED APPLICATION

The present application claims the filing benefits of U.S. provisional application Ser. No. 63/709,638, filed Oct. 21, 2024, which is hereby incorporated herein by reference in its entirety.

### FIELD OF THE INVENTION

The present invention relates generally to the field of rearview mirror assemblies for vehicles.

### BACKGROUND OF THE INVENTION

It is known to provide a vehicular exterior rearview mirror assembly that includes a foldable mirror assembly, such as a powerfold mirror where the mirror head is pivotable via an actuator between a drive or use position and a folded or park position.

### SUMMARY OF THE INVENTION

The present disclosure provides a rearview mirror assembly (such as an exterior mirror assembly mounted at a side of an equipped vehicle) or a camera wing at a side of the vehicle that includes a low profile powerfold actuator. For example, the mirror assembly includes a mirror head accommodating a mirror reflective element. A mounting base is configured for mounting the vehicular exterior rearview mirror assembly at a side of a vehicle equipped with the vehicular exterior rearview mirror assembly. With the vehicular exterior rearview mirror assembly mounted at the side of the vehicle, the mirror head is movable relative to the mounting base between at least (i) an extended position where the mirror head is extended outward from the side of the vehicle so that the mirror reflective element is positioned to provide a rearward view at the side of the vehicle to a driver of the vehicle and (ii) a folded position where the mirror head is moved inward from the extended position toward the side of the vehicle. With the vehicular exterior rearview mirror assembly mounted at the side of the vehicle, an actuator is electrically operable to move the mirror head relative to the mounting base between the folded position and the extended position. The actuator includes a base portion and a pivot tube that extends from the base portion. With the vehicular exterior rearview mirror assembly mounted at the side of the vehicle, the base portion is disposed at the mounting base. The pivot tube extends through an output gear of the actuator and a housing of the actuator. The mirror head and the housing of the actuator, when the actuator is electrically operated, move together and in tandem about a longitudinal axis of the pivot tube of the actuator. The output gear is rotatably fixed relative to the base portion of the actuator. The housing of the actuator, when the actuator is electrically operated, pivots about the output gear as the housing of the actuator moves about the longitudinal axis of the pivot tube. The actuator includes a biasing element that releasably retains the actuator in at least one detent state of the actuator. The biasing element is disposed between an upper end of the pivot tube and a surface of the housing. A portion of the housing of the actuator extends between the upper end of the pivot tube and the surface of the housing, and the biasing element is disposed radially inboard of the portion of the housing of the actuator relative to the longitudinal axis of the pivot tube.

These and other objects, advantages, purposes and features of the present invention will become apparent upon review of the following specification in conjunction with the drawings.

### BRIEF DESCRIPTION OF THE DRAWINGS

FIG. 1 is a plan view of an exterior rearview mirror assembly disposed at a side of a vehicle;

FIG. 2 is a view of the exterior rearview mirror assembly in an extended or use position;

FIG. 3 is a view of the exterior rearview mirror assembly pivoted from the extended position to a folded or non-use position;

FIGS. 4 and 5 are perspective views of an actuator of the exterior rearview mirror assembly;

FIG. 6 is a perspective view of the actuator, with washers and a biasing element removed to show interference features formed along a portion of the actuator housing;

FIG. 7 is a lower perspective view of the actuator;

FIG. 8 is a lower perspective view of the actuator, with a detent plate removed to show stop pins extending from a lower portion of the actuator housing;

FIG. 9 is a plan view of the actuator with the actuator housing rendered partially transparent;

FIG. 10 is a sectional view of the actuator; and

FIG. 11 is a sectional view of the actuator mounted at a mounting base of the vehicle.

### DESCRIPTION OF THE PREFERRED EMBODIMENTS

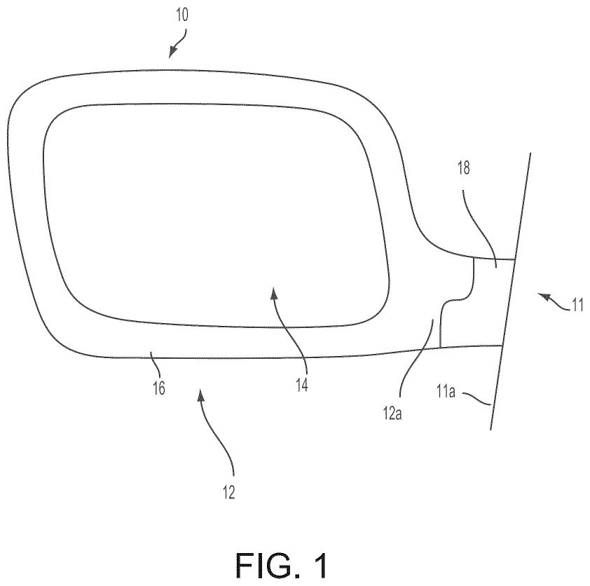

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIG. 1). The mirror head portion 12 includes a mounting portion 12a that is pivotally or movably mounted to a mounting arm or base or portion 18. The mirror assembly 10 comprises a powerfold mirror (where the mirror head portion may be pivoted via an actuator assembly or adjustment device), and may comprise a breakaway mirror (where the mirror head portion may be manually pivoted about the mounting arm or base). The mounting arm or base 18 of the mirror assembly 10 is mounted at the side 11a of a host or subject vehicle 11 equipped with the mirror assembly 10, with the reflective element 14 providing a rearward field of view along the respective side of the vehicle to the driver of the vehicle.

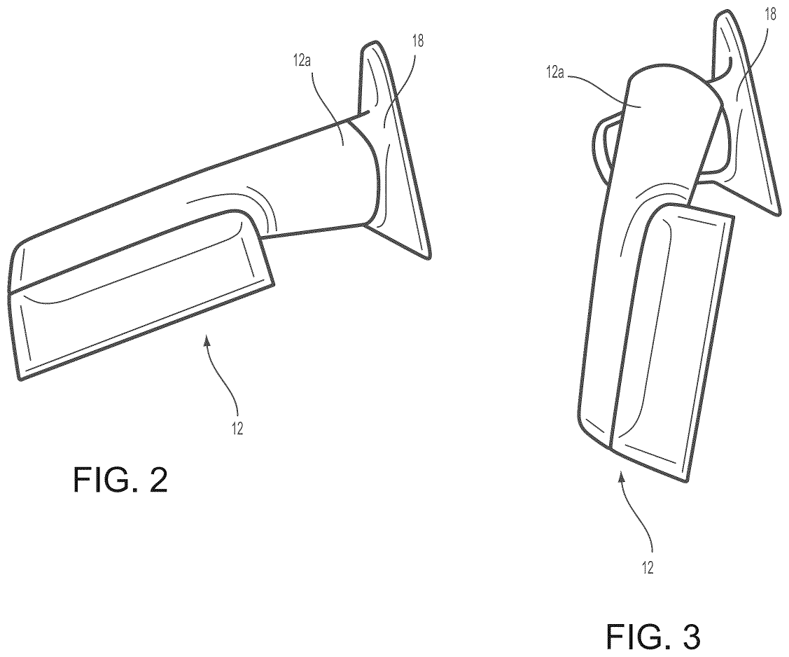

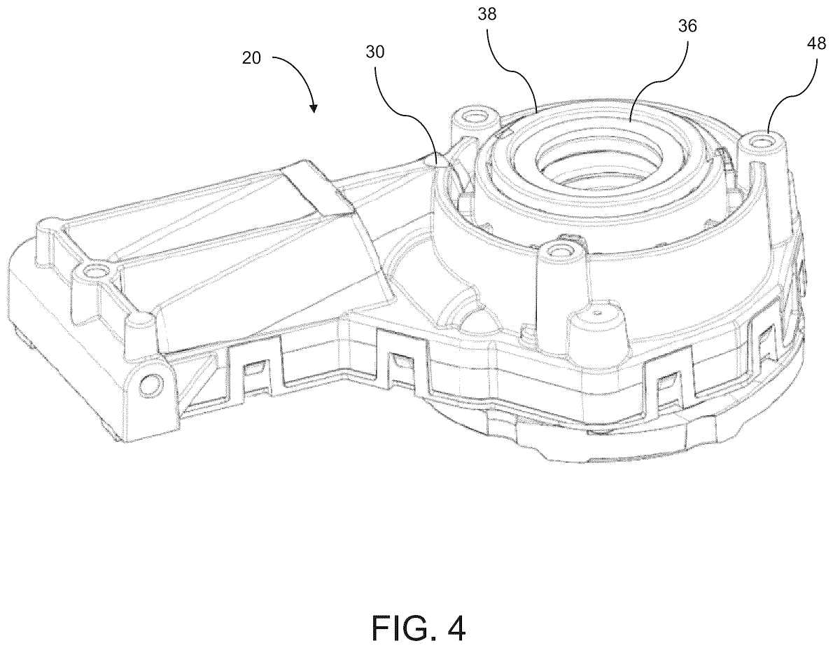

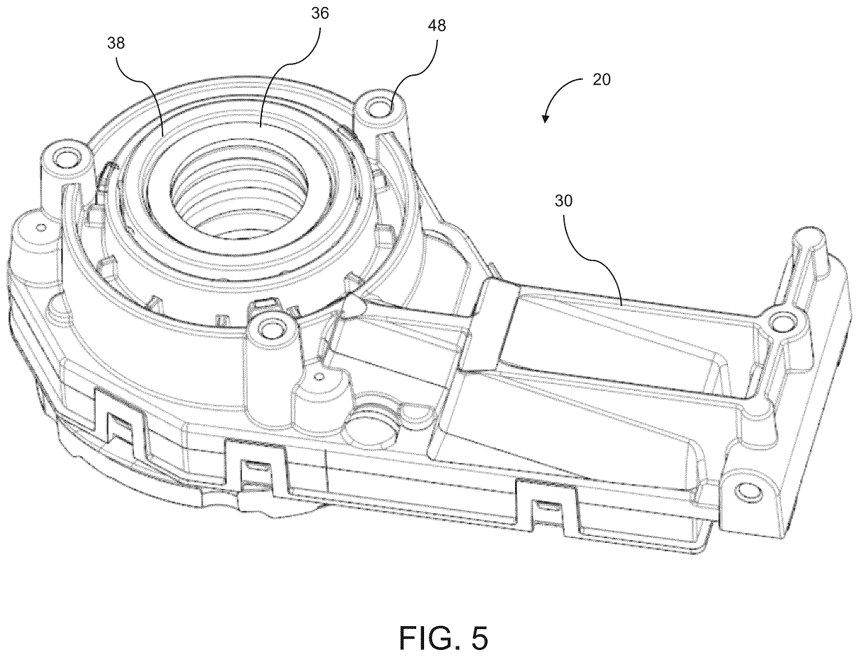

The powerfold mirror assembly 10 includes an actuator 20 (FIG. 4) that is electrically operable to pivot the mirror head 12 (comprising the mirror casing 16 and reflective element 14) relative to the mounting arm or base 18. The actuator 20 operates, such as responsive to a user input, to pivot the mirror head 12 between a plurality of detent positions, including a use or drive or extended position (FIG. 2) and a folded or park position (FIG. 3). The mirror head is also pivotable manually to either the use or folded position. The actuator may pivot the mirror head 12 between the use position and the folded position responsive to the user input, or the actuator may pivot the mirror head automatically, such as upon completion of performance of a parking maneuver of the vehicle or upon locking or unlocking of the doors of the vehicle.

When in the use or drive position, the mirror head 12 is extended from the side 11a of the vehicle 11 so as to provide the rearward field of view along the side of the vehicle to the driver of the vehicle. When in the folded or park position, the mirror head 12 is folded or pivoted or rotated from the extended position toward the side 11a of the vehicle 11, such that the mirror reflective element 14 may be facing the side of the vehicle and does not provide the rearward field of view along the side of the vehicle. Optionally, the mirror head 12 may also be pivoted to a fully forward position, where the mirror head 12 is folded or pivoted or rotated away from the folded position and beyond the use position, such that the mirror reflective element 14 may face sideward or forward away from the side 11a of the vehicle 11. The mirror head 12 may pivot toward the fully forward position manually, such as upon contact or a collision with an object. A seal may be disposed along the interface between the mounting portion 12a of the mirror head 12 and the mounting arm or base 18, such as to reduce noise or damage from vibration of the mirror head 12 relative to the mounting base 18 and/or to preclude moisture or debris from entering the mirror head 12 or mounting base 18.

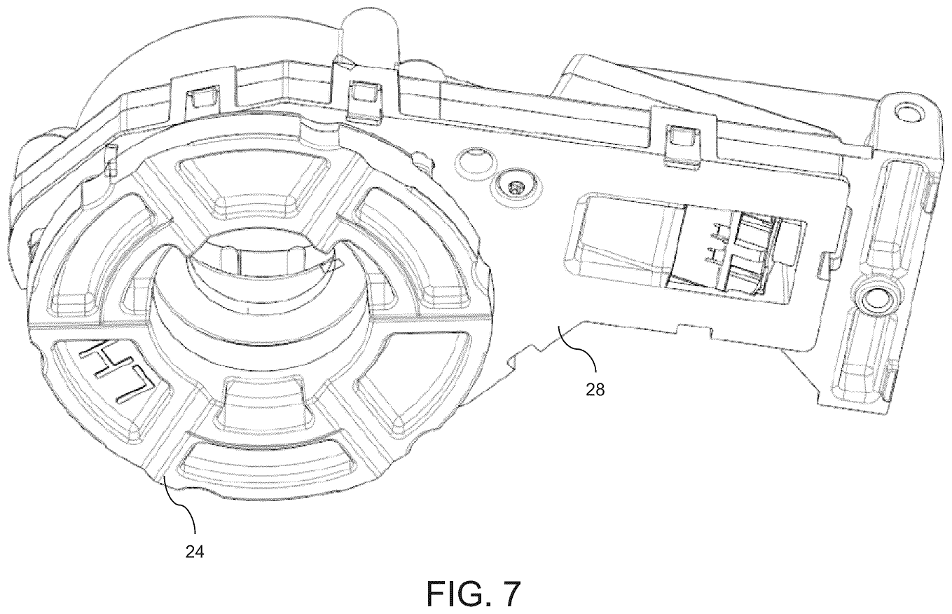

As shown in FIGS. 4-11, the actuator 20 comprises a pivot assembly that has a base post construction that is fixedly disposed at or attached at the mounting base 18 and that has a pivot tube or post 22 and a base 21 integrated together (or that has a separate base and pivot post joined together) with the pivot post 22 providing or defining a pivot axis for the mirror head 12 when the mirror head 12 is moved between the extended position, the folded position, and the fully forward position. The post 22 extends from the base 21 and extends through a lower detent plate 24 and an output gear 26 that are disposed at the post 22. The lower detent 24 and the output gear 26 may be keyed together and non-rotatable relative to one another, and the lower detent 24 and the output gear 26 may be rotatable together and in tandem relative to the post 22 and the base 21 when the mirror head 12 is manually pivoted.

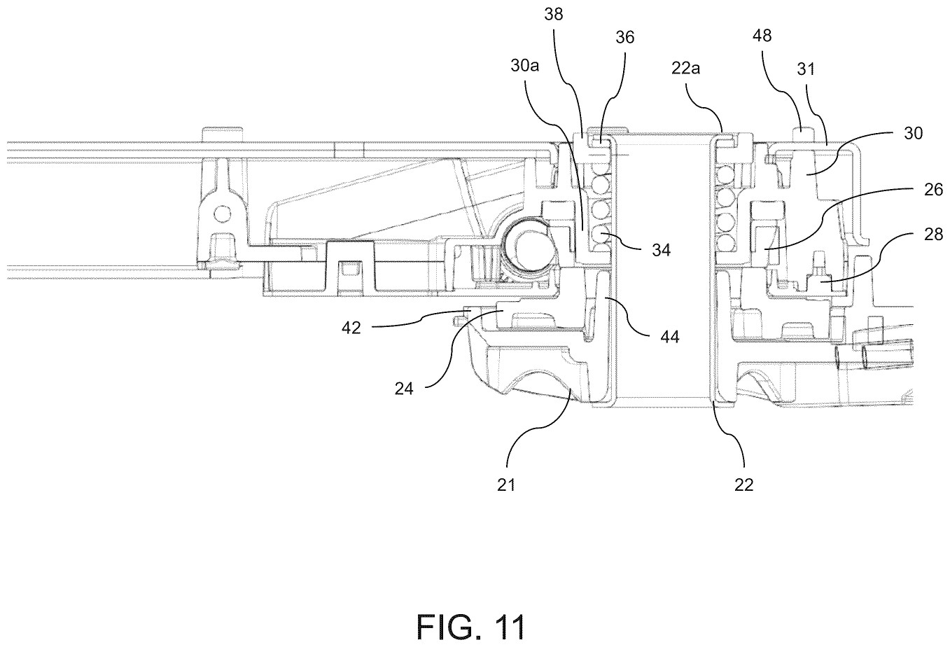

An actuator housing or bracket, comprising a lower housing 28 and an upper housing 30, is rotatably disposed at the post 22 and houses one or more electrically operable motors 32 that, when electrically operated, cause the actuator housing to rotate or pivot about the post 22. The actuator housing is non-rotatably disposed or attached at the mirror head 12 so that movement or rotation of the actuator housing about the pivot axis of the pivot post 22 translates to movement or rotation of the mirror head 12. Thus, the one or more motors 32 are actuated to pivot or rotate the actuator housing, and therefore the mirror head 12, about the pivot axis. Optionally, a mounting bracket 31 is disposed at the housing for mounting the housing to the mirror head (FIG. 11).

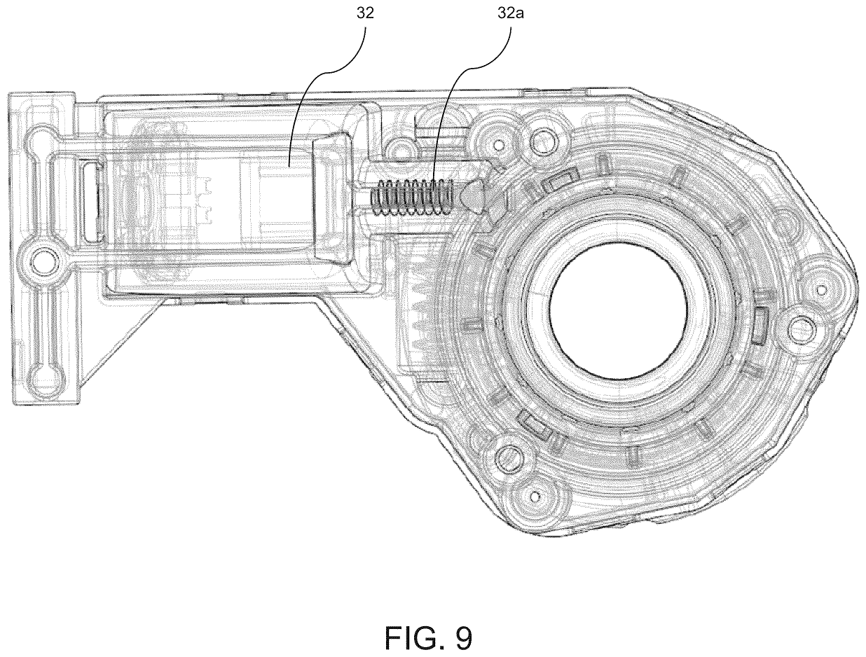

The one or more motors 32 are actuated to rotatably drive one or more gears of a gear train 32a (FIG. 9), which engages the output gear 26 and rotates or pivots the housing relative to the output gear 26 until a hard stop is engaged (such as with the mirror head at the extended position), whereby the motor will stall or stop, with the mirror head 12 retained at the extended or drive position via detent elements or engagements or states of the actuator. The actuator 20 is configured such that a hard stop is provided at the appropriate locations when the mirror head 12 is pivoted via driving of the motor to position the mirror head as desired, such as at the folded position and at the use position.

The post 22 extends from the base 21 and through the lower detent or detent plate 24 and the output gear 26. The lower detent 24 may be disposed between the lower housing 28 and the base 21 and engage the output gear 26 through an aperture of the lower housing 28. The upper housing portion 30 attaches to the lower housing 28 and encloses a portion of the post 22, the motors 32 and gear train 32a, the output gear 26, and at least a portion of the lower detent 24. The output gear 26 and the lower detent plate 24 may be keyed together and may not rotate or move relative to one another such that the output gear 26 and lower detent 24 may not rotate relative to the post 22 during electric actuation of the actuator 20 via operation of the motors 32. The actuator may utilize aspects of the actuators described in in U.S. Pat. Nos. 11,396,264; 11,173,843; 10,099,618; 9,827,913; 9,487,142; 9,346,403; 9,067,541 and/or 7,887,202, and/or U.S. Publication Nos. US-2023-0009664; US-2022-0126751; US-2021-0261053; US-2020-0353867 and/or US-2020-0223364, which are all hereby incorporated herein by reference in their entireties.

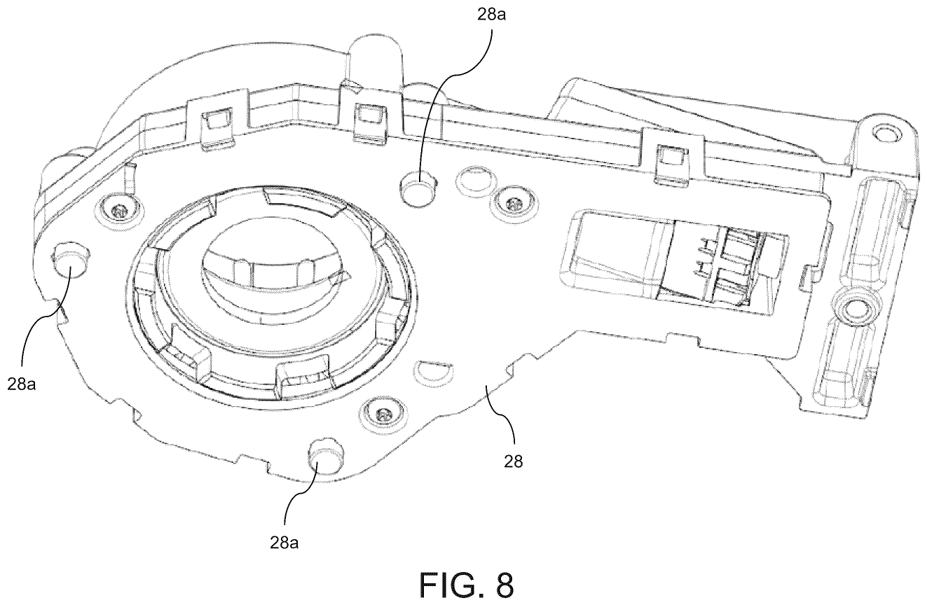

That is, the output gear 26 and the lower detent plate 24 may be rotationally keyed to one another so that, when the motor 32 is electrically operated to move the mirror head between the extended position and the folded position, the actuator housing and the mirror head move about the output gear 26 relative to the detent plate 24. The detent plate 24 may include detent structure or detent elements that engage a lower surface of the lower housing 28 and cause the actuator housing and the mirror head to move along the longitudinal axis of the pivot post 22 during rotation of the mirror head, such as to lift the mirror head relative to the mounting base when pivoting from the extended position toward the folded position. When the mirror head is manually moved between the folded position and the drive position, the output gear 26 and the detent plate 24 may pivot with the actuator housing and the mirror head about the pivot post 22, with detent features between a lower surface of the detent plate 24 and the mirror base causing the mirror head to move along the longitudinal axis of the pivot post 22 as the mirror head pivots. The lower housing 28 may include stop pins 28a that extend from the lower surface of the lower housing 28 and cinch the detent plate 24 when the mirror head is moved to the drive position (FIG. 8).

The pivot post 22 includes a flange or a retainer 22a extending radially from an upper end of the pivot post 22 and a biasing element 34, such as a coil spring or wave spring, is disposed along the pivot post 22 between the retainer 22a and a portion of the actuator to bias the detent features of the actuator into engagement. In the illustrated example, the biasing element 34 includes a coil spring disposed between the retainer 22a and an upper surface of the upper housing 30. Further, the biasing element 34 is at least partially disposed within a recess or cavity or spring cup portion 30a of the upper housing 30 that is accommodated within or along a recess or cavity of the output gear 26. That is, the upper housing 30 includes a portion or surface that extends radially outboard of the pivot post 22 at or near the retainer 22a and the upper housing 30 includes another portion or surface that extends axially along the pivot post 22 between the retainer 22a and the mounting base 21. This portion of the upper housing 30 may extend along the pivot post 22 and radially inboard of at least a portion of the output gear 26 and optionally the detent plate 24, with an inward extending portion of the upper housing 30 disposed along the pivot post 22 beneath the retainer 22a for receiving an end of the biasing element 34. The spring cup portion 30a may be concentric with one or more of an aperture formed through the upper housing 30, the pivot post 22 and the output gear 26. Thus, the biasing element 34 is disposed between the retainer 22a and the outer surface of the upper housing 30 and radially inboard of at least a portion of the upper housing 30 and at least a portion of the output gear 26. This may reduce the packaging height of the powerfold actuator 20 along the pivot post 22 and thus allow the powerfold actuator 20 to be utilized with smaller exterior mirror heads, camera wings and the like.

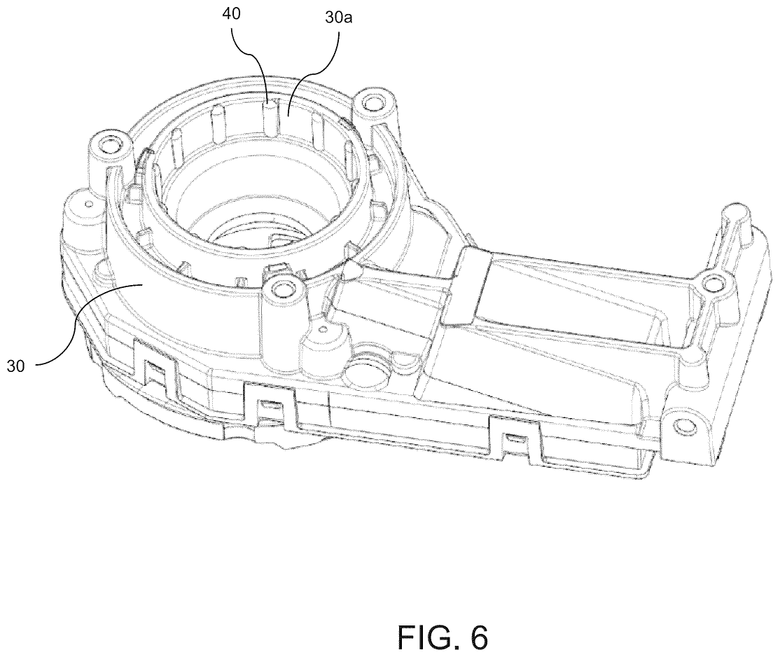

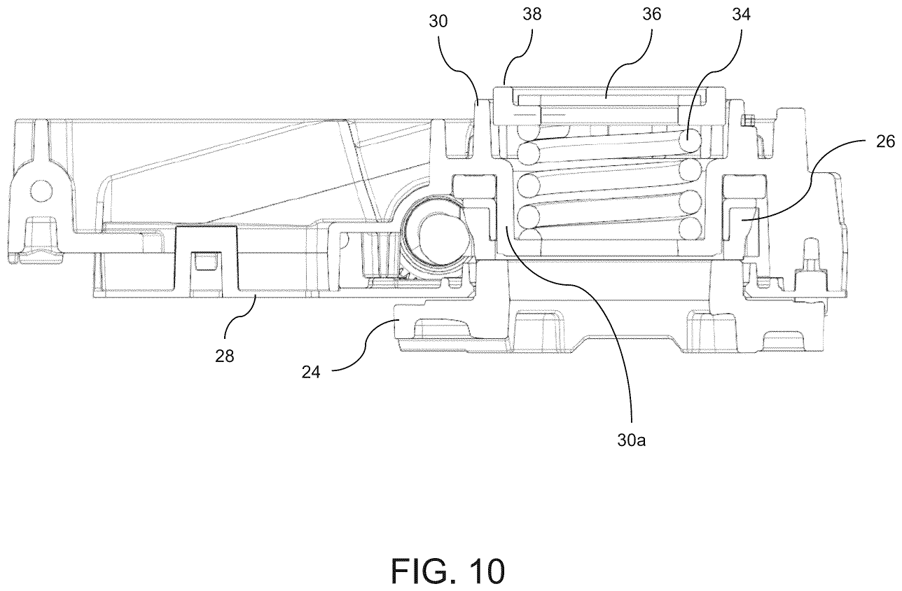

One or more slip washers 36 and/or pivot washers 38 may be disposed between the retainer 22a and the upper end of the biasing element 34 to enable pivoting of the actuator housing and one or both of the slip washer 36 and pivot washer 38 relative to the biasing element 34 and pivot post 22 (FIGS. 10 and 11). The slip washer 36 may be disposed between at least a portion of the pivot washer 38 and the retainer 22a with the pivot washer 38 disposed between the slip washer 36 and the upper end of the biasing element 34. To further reduce the vertical packaging height of the actuator along the pivot post 22, interference features or ribs 40 may be formed along the spring cup portion 30a of the upper housing 30 to rotationally fix the pivot washer 38 relative to the upper housing 30 (FIG. 6). That is, the upper housing 30 may include a plurality of radially protruding ribs or interference features 40 that protrude from the cylindrical surface of the spring cup portion 30a toward the pivot post 22 and that extend axially along the spring cup portion 30a to provide an interference fit between the upper housing 30 and the pivot washer 38.

Moreover, support rings may extend from the mirror base 21 and at least partially along the detent plate 24 and the pivot post 22 to provide added structural support for the actuator 20 while disposing the actuator 20 at least partially within a recess of the mirror base 21 and thus further reducing the vertical packaging height of the actuator and mirror head. In other words, the mirror base 21 includes a first support ring 42 extending at least partially along the detent plate 24 and the pivot post 22 and radially outboard of the detent plate 24. A second support ring 44 extends along the pivot post 22 radially inboard of the detent plate 24 and at least partially between the detent surface of the mirror base 21 and the upper housing 30. Thus, the first support ring 42 and the second support ring 44 maintain support structure stiffness and vibration stability of the mirror head, with increased support of the pivot tube 22 while reducing the vertical packaging height of the mirror head.

In other words, the exterior mirror folding mechanism includes the base structure 21 rigidly mounted to the vehicle and having detent features and the powerfold actuator 20. The powerfold actuator 20 includes the rotating detent plate 24, the actuator body or housing containing one or more motors 32, a gear train 32a and other components to create a rigid and stable connection between the vehicle and the mirror glass. Further, the actuator 20 includes a spring 34 to apply compressive force between the detent features on the mirror base structure 21 and the powerfold detent plate 24, a washer or series of washers which provide a rotating slip joint and a structural link to the mirror bracket structure 31, and a pivot post 22, which retains the aforementioned components in alignment with the mirror pivot axis and may counteract the compressive spring load.

These components may be stacked one on top of another. This can lead to a stack-up of dimension that can cause difficulty when packaging a power fold actuator within a confined or styled packaging space.

The compact powerfold actuator 20 significantly reduces the stack-up height by at least partially nesting the pivot spring 34 inside of the actuator housing and the output gear 26. Further, the stack-up height is reduced by integrating the spring cup 30a and pivot washer interference features 40 into the actuator housing. Another method of height reduction (while maintaining support structure stiffness and vibration stability) includes extruding the first support ring 42 up from the detent features on the mirror base 21 outside of the detent plate 24 outer diameter and extruding the second support ring 44 inside of the detent plate 24 inner pivot hole. Moreover, the actuator 20 includes several attachment features 48 integrated into the actuator housing, allowing a rigid interface between the powerfold actuator 20 and the mirror bracket 31. The actuator 20 includes a greater gear ratio than is typical of similarly sized actuators, resulting in high torque output. The actuator detent plate 24 may be supported by three stop pins 28a when the actuator is cinched into drive position.

The compact powerfold actuator may be used in a wide variety of applications, such as wherever compactness can be appreciated without compromising performance. The actuator may be used in small, sleek car outside mirrors or in large, heavy single or twin-arm tow outside mirrors. For example, the slim exterior rearview mirror assembly may include one actuator 20 for moving the mirror head between the folded position and the extended position. The dual-arm exterior rearview mirror assembly may include two actuators, one mounted between the mounting base and each respective arm of the mirror assembly, that operate together and in tandem to move the mirror head between the folded position and the extended position. For example, the mirror assembly may utilize characteristics of the mirror assemblies described in U.S. Pat. No. 11,845,383 and/or 11,718,232, and/or U.S. Publication No. US-2023-0012333, which are hereby incorporated herein by reference in their entireties.

In some examples, a camera or other sensor (such as a radar sensor, lidar sensor, ultrasonic sensor, and the like) is disposed at the mirror head 12 for capturing sensor data representative of regions exterior of the vehicle. For example, with the mirror head in the extended position, the camera may capture image data representative of a region that is at least along the side of the vehicle and that is processed as part of a surround view camera system or camera monitoring system (CMS) of the vehicle. Optionally, sensor data may be processed for an advanced driver assistance system (ADAS) of the vehicle, such as for a lane keep assist function or a blind spot monitoring function. Because the mirror head 12 is movable between the folded position and the extended position, misalignment of the mirror head 12 at the extended position (e.g., due to mechanical drift over the lifecycle of the mirror assembly, due to manufacturing tolerances in the mirror assembly, due to damage to the mirror assembly and the like) can cause errors in processing of the captured sensor data. Thus, the powerfold actuator 20 provides reliable and repeatable positioning of the mirror head 12 relative to the mounting base when the mirror head 12 is moved to the extended position. Optionally, the powerfold actuator 20 is used to mount a camera wing at the side of the vehicle, where the camera wing includes the camera for providing the rearward field of view to the driver of the vehicle, such as at a display device within the cabin of the vehicle.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Optionally, the mirror assembly may include an imaging sensor (such as a sideward and/or rearward facing imaging sensor or camera that has a sideward/rearward field of view at the side of the vehicle at which the exterior mirror assembly is mounted) that may be part of or may provide an image output for a vehicle vision system, such as a lane departure warning system or object detection system or blind zone alert system or surround view vision system other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mirror head accommodating a mirror reflective element;
a mounting base configured for mounting the vehicular exterior rearview mirror assembly at a side of a vehicle;
wherein, with the vehicular exterior rearview mirror assembly mounted at the side of the vehicle, the mirror head is movable relative to the mounting base between at least (i) an extended position where the mirror head is extended outward from the side of the vehicle so that the mirror reflective element is positioned to provide a rearward view at the side of the vehicle to a driver of the vehicle and (ii) a folded position where the mirror head is moved inward from the extended position toward the side of the vehicle;
an actuator, wherein, with the vehicular exterior rearview mirror assembly mounted at the side of the vehicle, the actuator is electrically operable to move the mirror head relative to the mounting base between the folded position and the extended position;
wherein the actuator comprises a base portion and a pivot tube that extends from the base portion, and wherein, with the vehicular exterior rearview mirror assembly mounted at the side of the vehicle, the base portion is disposed at the mounting base;
wherein the pivot tube extends through an output gear of the actuator and a housing of the actuator;
wherein the mirror head and the housing, when the actuator is electrically operated to move the mirror head between the extended position and the folded position, move together and in tandem about a longitudinal axis of the pivot tube of the actuator;
wherein, when the actuator is electrically operated to move the mirror head between the extended position and the folded position, (i) the output gear is rotatably fixed relative to the base portion and (ii) the housing pivots about the output gear;
wherein the actuator comprises a biasing element that releasably retains the actuator in at least one detent state of the actuator, and wherein, with the vehicular exterior rearview mirror assembly mounted at the side of the vehicle, the biasing element is disposed between an upper end of the pivot tube and an engagement surface of the housing; and
wherein a portion of the housing is disposed at least partially between the upper end of the pivot tube and the engagement surface of the housing, and wherein the biasing element is disposed radially inboard of the portion of the housing relative to the longitudinal axis of the pivot tube.

2. The vehicular exterior rearview mirror assembly of claim 1, wherein the portion of the housing is disposed radially inboard of at least a portion of the output gear relative to the longitudinal axis of the pivot tube.

3. The vehicular exterior rearview mirror assembly of claim 1, wherein a washer is disposed between the upper end of the pivot tube and the biasing element, and wherein an interference feature extends radially inward from the portion of the housing toward the pivot tube, and wherein the washer engages the interference feature to axially fix the washer relative to the housing.

4. The vehicular exterior rearview mirror assembly of claim 3, wherein the interference feature comprises a plurality of ribs that extend along the portion of the housing in a direction parallel to the longitudinal axis of the pivot tube.

5. The vehicular exterior rearview mirror assembly of claim 4, wherein individual ribs of the plurality of ribs are circumferentially spaced from one another about the longitudinal axis of the pivot tube.

6. The vehicular exterior rearview mirror assembly of claim 1, wherein the base portion comprises a detent plate, and wherein the detent plate comprises a plurality of detents that, when the actuator is in the at least one detent state of the actuator, engage a corresponding plurality of detents of the housing.

7. The vehicular exterior rearview mirror assembly of claim 6, wherein, when the mirror head is manually moved between the extended position and the folded position, the output gear and the detent plate move together and in tandem with the mirror head and the housing about the longitudinal axis of the pivot tube.

8. The vehicular exterior rearview mirror assembly of claim 7, wherein, with the mirror head in the extended position, a stop pin of the housing of the actuator engages the detent plate to cinch the actuator.

9. The vehicular exterior rearview mirror assembly of claim 6, wherein the mounting base includes a structural support ring that extends in a direction parallel to the longitudinal axis of the pivot tube and at least partially along the detent plate.

10. The vehicular exterior rearview mirror assembly of claim 9, wherein the structural support ring extends radially outboard of the detent plate relative to the longitudinal axis of the pivot tube.

11. The vehicular exterior rearview mirror assembly of claim 9, wherein the structural support ring extends radially inboard of the detent plate relative to the longitudinal axis of the pivot tube.

12. The vehicular exterior rearview mirror assembly of claim 6, wherein the mounting base includes (i) a first structural support ring that extends in a direction parallel to the longitudinal axis of the pivot tube at least partially along the detent plate and extends radially outboard of the detent plate relative to the longitudinal axis of the pivot tube and (ii) a second structural support ring that extends in a direction parallel to the longitudinal axis of the pivot tube at least partially along the detent plate and extends radially inboard of the detent plate relative to the longitudinal axis of the pivot tube.

13. A vehicular exterior rearview mirror assembly, the vehicular exterior rearview mirror assembly comprising:
a mirror head accommodating a mirror reflective element;
a mounting base configured for mounting the vehicular exterior rearview mirror assembly at a side of a vehicle;
wherein, with the vehicular exterior rearview mirror assembly mounted at the side of the vehicle, the mirror head is movable relative to the mounting base between at least (i) an extended position where the mirror head is extended outward from the side of the vehicle so that the mirror reflective element is positioned to provide a rearward view at the side of the vehicle to a driver of the vehicle and (ii) a folded position where the mirror head is moved inward from the extended position toward the side of the vehicle;
an actuator, wherein, with the vehicular exterior rearview mirror assembly mounted at the side of the vehicle, the actuator is electrically operable to move the mirror head relative to the mounting base between the folded position and the extended position;
wherein the actuator comprises a base portion and a pivot tube that extends from the base portion, and wherein, with the vehicular exterior rearview mirror assembly mounted at the side of the vehicle, the base portion is disposed at the mounting base;
wherein the pivot tube extends through an output gear of the actuator and a housing of the actuator;
wherein the mirror head and the housing, when the actuator is electrically operated to move the mirror head between the extended position and the folded position, move together and in tandem about a longitudinal axis of the pivot tube of the actuator;
wherein, when the actuator is electrically operated to move the mirror head between the extended position and the folded position, (i) the output gear is rotatably fixed relative to the base portion and (ii) the housing pivots about the output gear;
wherein the actuator comprises a biasing element that releasably retains the actuator in at least one detent state of the actuator, and wherein, with the vehicular exterior rearview mirror assembly mounted at the side of the vehicle, the biasing element is disposed between an upper end of the pivot tube and an engagement surface of the housing, and wherein a washer is disposed between the upper end of the pivot tube and the biasing element;
wherein a portion of the housing is disposed at least partially between the upper end of the pivot tube and the engagement surface of the housing, and wherein the biasing element is disposed radially inboard of the portion of the housing relative to the longitudinal axis of the pivot tube, and wherein the portion of the housing and the biasing element are disposed radially inboard of at least a portion of the output gear relative to the longitudinal axis of the pivot tube; and
wherein an interference feature extends radially inward from the portion of the housing toward the pivot tube, and wherein the washer engages the interference feature to axially fix the washer relative to the housing.

14. The vehicular exterior rearview mirror assembly of claim 13, wherein the interference feature comprises a plurality of ribs that extend along the portion of the housing in a direction parallel to the longitudinal axis of the pivot tube, and wherein individual ribs of the plurality of ribs are circumferentially spaced from one another about the longitudinal axis of the pivot tube.

15. The vehicular exterior rearview mirror assembly of claim 13, wherein the base portion comprises a detent plate, and wherein the detent plate comprises a plurality of detents that, when the actuator is in the at least one detent state of the actuator, engage a corresponding plurality of detents of the housing.

16. The vehicular exterior rearview mirror assembly of claim 15, wherein, when the mirror head is manually moved between the extended position and the folded position, the output gear and the detent plate move together and in tandem with the mirror head and the housing about the longitudinal axis of the pivot tube.

17. A vehicular exterior rearview mirror assembly, the vehicular exterior rearview mirror assembly comprising:
a mirror head accommodating a mirror reflective element;
a mounting base configured for mounting the vehicular exterior rearview mirror assembly at a side of a vehicle;
wherein, with the vehicular exterior rearview mirror assembly mounted at the side of the vehicle, the mirror head is movable relative to the mounting base between at least (i) an extended position where the mirror head is extended outward from the side of the vehicle so that the mirror reflective element is positioned to provide a rearward view at the side of the vehicle to a driver of the vehicle and (ii) a folded position where the mirror head is moved inward from the extended position toward the side of the vehicle;
an actuator, wherein, with the vehicular exterior rearview mirror assembly mounted at the side of the vehicle, the actuator is electrically operable to move the mirror head relative to the mounting base between the folded position and the extended position;
wherein the actuator comprises a base portion and a pivot tube that extends from the base portion, and wherein, with the vehicular exterior rearview mirror assembly mounted at the side of the vehicle, the base portion is disposed at the mounting base;
wherein the pivot tube extends through an output gear of the actuator and a housing of the actuator;
wherein the mirror head and the housing, when the actuator is electrically operated to move the mirror head between the extended position and the folded position, move together and in tandem about a longitudinal axis of the pivot tube of the actuator;
wherein, when the actuator is electrically operated to move the mirror head between the extended position and the folded position, (i) the output gear is rotatably fixed relative to the base portion and (ii) the housing pivots about the output gear;
wherein the actuator comprises a biasing element that releasably retains the actuator in at least one detent state of the actuator, and wherein, with the vehicular exterior rearview mirror assembly mounted at the side of the vehicle, the biasing element is disposed between an upper end of the pivot tube and an engagement surface of the housing;
wherein the base portion comprises a detent plate, and wherein the detent plate comprises a plurality of detents that, when the actuator is in the at least one detent state of the actuator, engage a corresponding plurality of detents of the housing;
wherein, when the mirror head is manually moved between the extended position and the folded position, the output gear and the detent plate move together and in tandem with the mirror head and the housing about the longitudinal axis of the pivot tube; and
wherein a portion of the housing is disposed at least partially between the upper end of the pivot tube and the engagement surface of the housing, and wherein the biasing element is disposed radially inboard of the portion of the housing relative to the longitudinal axis of the pivot tube, and wherein the portion of the housing and the biasing element are disposed radially inboard of at least a portion of the output gear relative to the longitudinal axis of the pivot tube.

18. The vehicular exterior rearview mirror assembly of claim 17, wherein, with the mirror head in the extended position, a stop pin of the housing of the actuator engages the detent plate to cinch the actuator.

19. The vehicular exterior rearview mirror assembly of claim 17, wherein the mounting base includes a structural support ring that extends in a direction parallel to the longitudinal axis of the pivot tube and at least partially along the detent plate, and wherein one selected from the group consisting of (i) the structural support ring extends radially outboard of the detent plate relative to the longitudinal axis of the pivot tube and (ii) the structural support ring extends radially inboard of the detent plate relative to the longitudinal axis of the pivot tube.

20. The vehicular exterior rearview mirror assembly of claim 17, wherein the mounting base includes (i) a first structural support ring that extends in a direction parallel to the longitudinal axis of the pivot tube at least partially along the detent plate and extends radially outboard of the detent plate relative to the longitudinal axis of the pivot tube and (ii) a second structural support ring that extends in a direction parallel to the longitudinal axis of the pivot tube at least partially along the detent plate and extends radially inboard of the detent plate relative to the longitudinal axis of the pivot tube.
